(19) United States
(12) Patent Application Publication
(10) Pub. No.: US 2005/0189906 A1
(43) Pub. Date: Sep. 1, 2005

(54) Battery arrangement for wrist-carried device

(76) Inventor: Huei-Hsin Sun, Taipei City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/790,320

(22) Filed: Mar. 1, 2004

(51) Int. Cl. H02J 7/00

(52) U.S. Cl. 320/107

(57) ABSTRACT

A battery arrangement for a wrist-carried portable device (e.g., bracelet, cellular phone, or wrist watch) is provided. The battery arrangement comprises one or more flexible, arcuate, thin batteries (e.g., lithium polymer batteries) fitted in a recess of an outer surface of the device and being electrically coupled a circuitry of the means, and a cover clung onto the batteries for fastening the batteries. In another configuration, the battery arrangement comprises an arcuate outer cover having an arcuate recess on an inner surface, a plurality of spaced batteries disposed in the recess, a link coupled the batteries together, and an arcuate inner cover clung onto the outer cover for fastening the batteries.

### BACKGROUND OF THE INVENTION

1. Field of the Invention

The present invention relates to wrist-carried devices and more particularly to a battery arrangement for a wrist-carried portable device.

2. Description of Related Art

Batteries for powering wrist-carried portable devices are well known. For example, U.S. Pat. No. 5,872,744 discloses a battery arrangement for a wrist-carried radiotelephone wherein batteries 26, 28, 30, and 32 are disposed in a plurality of links 18, 20, 22, and 24 and are electrically coupled together for providing power to the radiotelephone circuitry in a housing 16.

Thus, it is desirable of having continuing improvements in the exploitation of wrist-carried portable devices, particularly a battery arrangement suitable for such applications.

### SUMMARY OF THE INVENTION

It is an object of the present invention to provide a wrist-carried portable device, comprising means (e.g., bracelet, cellular phone, or wrist watch) including an arcuate recess on an outer surface; and a battery compartment including one or more flexible, arcuate, thin batteries fitted in the recess, and a cover clung onto the batteries for fastening the batteries in the recess, wherein the batteries are electrically coupled a circuitry of the means.

It is another object of the present invention to provide a wrist-carried portable device, comprising means (e.g., bracelet, cellular phone, or wrist watch) including an arcuate recess on an outer surface; and a battery compartment including an arcuate outer cover having an arcuate recess on an inner surface, a plurality of spaced batteries disposed in the recess, a link coupled the batteries together, and an arcuate inner cover clung onto the outer cover for fastening the batteries in the recess, wherein the batteries are electrically coupled a circuitry of the means.

In one aspect of the present invention each of the batteries is a lithium polymer battery.

The above and other objects, features and advantages of the present invention will become apparent from the following detailed description taken with the accompanying drawings.

### BRIEF DESCRIPTION OF THE DRAWINGS

FIG. 1 is an exploded view of a first preferred embodiment of wrist-carried portable device having a battery arrangement according to the invention;

FIG. 2 is a side view in part section of the assembled device shown in FIG. 1;

FIG. 3 is an exploded view of a second preferred embodiment of wrist-carried portable device having a battery arrangement according to the invention;

FIG. 4 is a side view in part section of the assembled device shown in FIG. 3;

FIG. 5 is an exploded view of a third preferred embodiment of wrist-carried portable device having a battery arrangement according to the invention;

FIG. 6 is a side view in part section of the assembled device shown in FIG. 5; and

FIG. 7 is an exploded view of a battery arrangement constructed in accordance with another configuration of the invention.

### DETAILED DESCRIPTION OF THE PREFERRED EMBODIMENTS

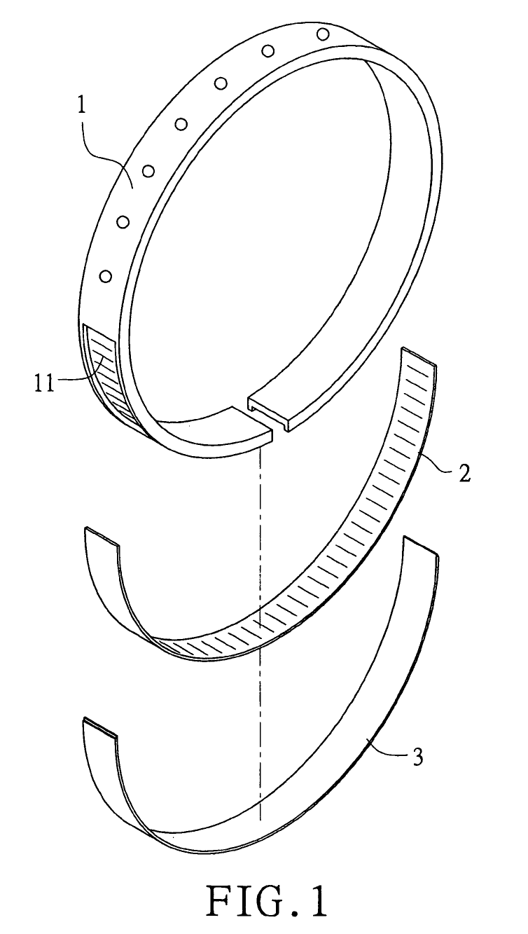

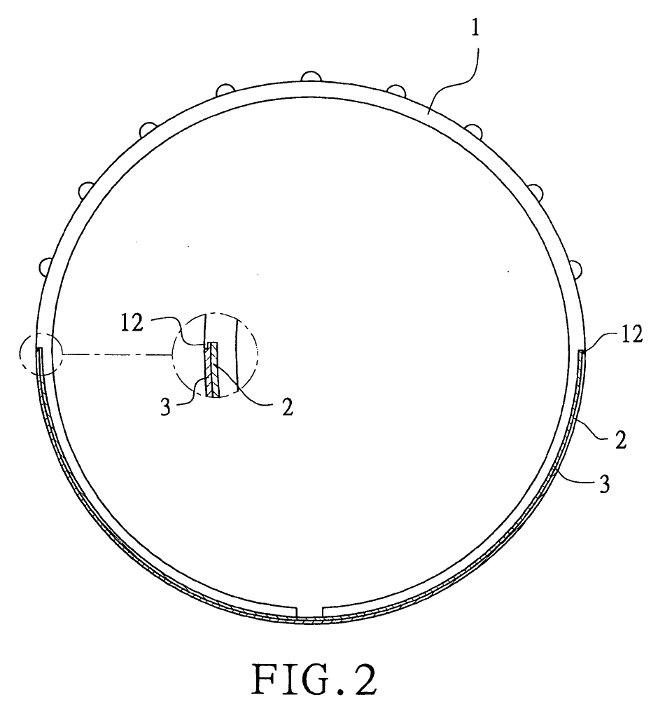

Referring to FIGS. 1 and 2, a first preferred embodiment of wrist-carried portable device (e.g., C-shaped bracelet) 1 according to the invention is shown. The bracelet 1 comprises an arcuate recess 11 on one half of an outer surface portion. A flexible, arcuate, thin battery 2 is fitted in the recess 11. A cover 3 is clung onto the recess 11 for fastening the battery 2 in the recess 11 (see the detailed view of the area in circle in FIG. 2). In the embodiment, the battery 2 is a lithium polymer battery. Also, the battery 2 is electrically coupled the circuitry (not shown) within the bracelet 1 for providing power thereto (i.e., emitting light or flashing). Further, the bracelet 1 thus formed has an aesthetic appearance.

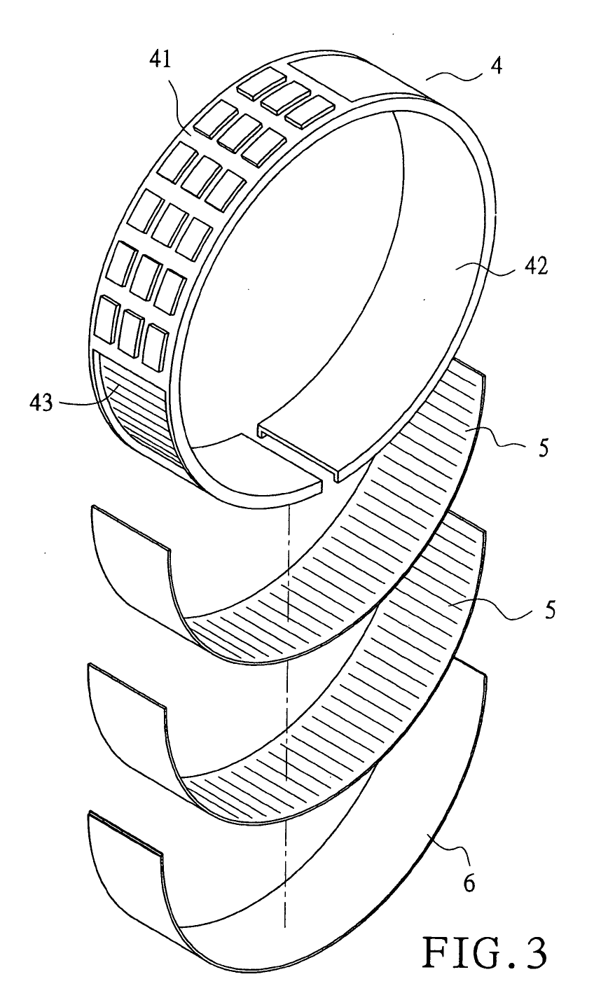

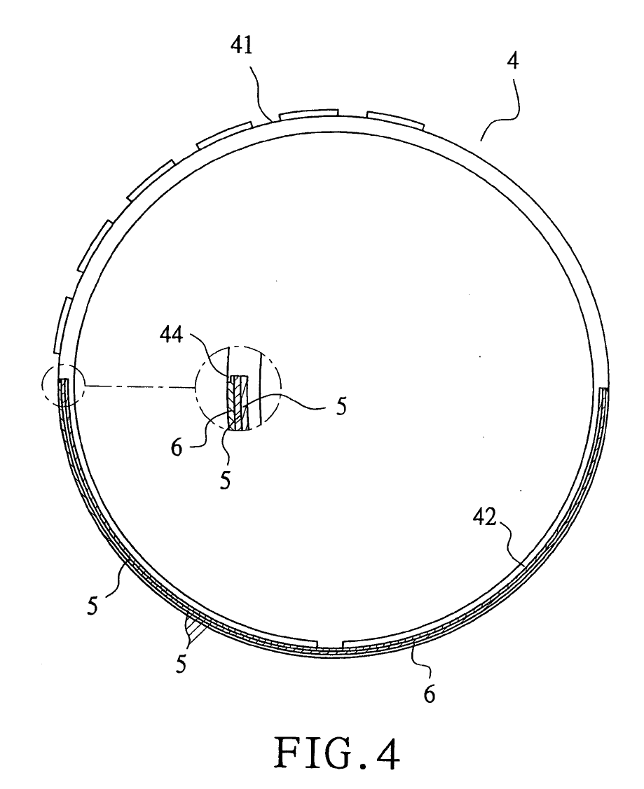

Referring to FIGS. 3 and 4, a second preferred embodiment of wrist-carried portable device (e.g., C-shaped cellular phone) 4 according to the invention is shown. The cellular phone 4 comprises an arcuate recess 41 on one half of an outer surface portion. Two flexible, arcuate, thin batteries 5 in covering relation are fitted in the recess 41. A cover 6 is clung onto the recess 41 for fastening the batteries 5 in the recess 41 (see the detailed view of the area in circle in FIG. 4). In the embodiment, the battery 5 is a lithium polymer battery. Also, the batteries 5 are electrically coupled the circuitry (not shown) within the cellular phone 4 for providing power thereto. Further, the cellular phone 4 thus formed has an aesthetic appearance.

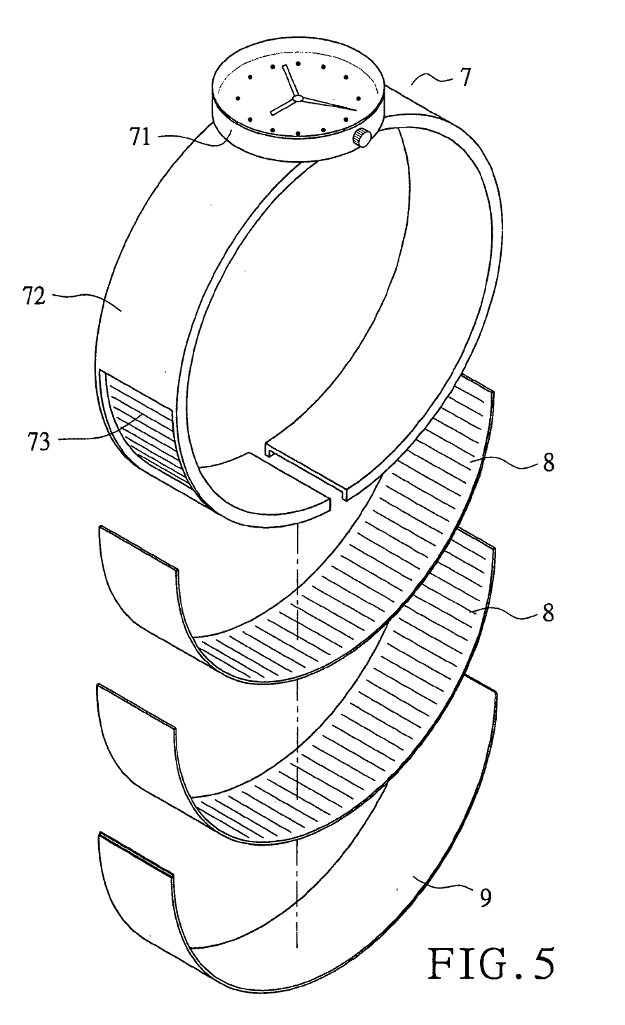

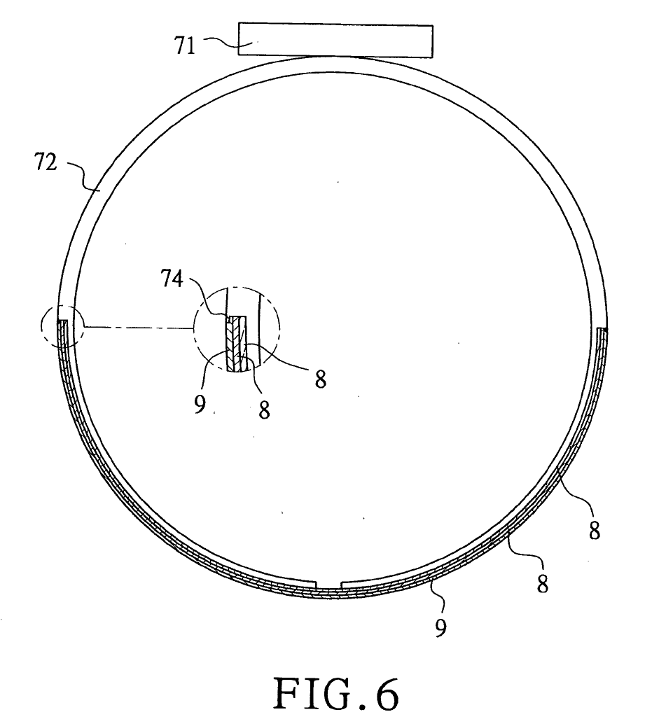

Referring to FIGS. 5 and 6, a third preferred embodiment of wrist-carried portable device (e.g., C-shaped wrist watch) 7 according to the invention is shown. The wrist watch 7 comprises a housing 71 for containing circuitry and mechanisms, and an arcuate recess 73 on one half of an outer surface portion of a somewhat rigid wrist band 72 thereof. Two flexible, arcuate, thin batteries 8 in covering relation are fitted in the recess 73. A cover 9 is clung onto the recess 73 for fastening the batteries 8 in the recess 73 (see the detailed view of the area in circle in FIG. 6). In the embodiment, the battery 8 is a lithium polymer battery. Also, the batteries 8 are electrically coupled the circuitry within the housing 71 for providing power to the wrist watch 7. Further, the wrist watch 7 thus formed has an aesthetic appearance.

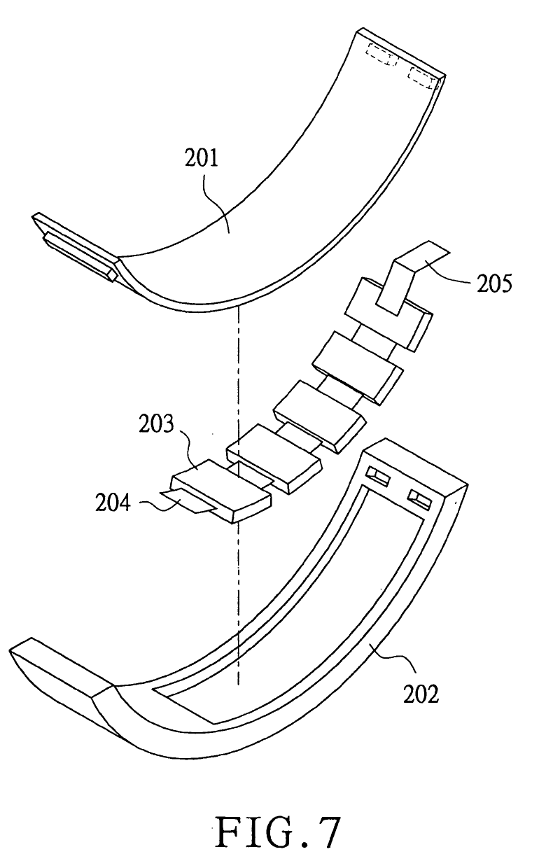

Referring to FIG. 7, another configuration of the battery arrangement is shown. The battery arrangement comprises an arcuate outer cover 202 having an arcuate recess on an inner surface, a plurality of spaced batteries 203 disposed in the recess of the outer cover 202, a link 204 for coupling the batteries 203 together, positive and negative terminals 205 at one end of the link 204, the terminals 205 being electrically coupled the circuitry within the housing of any of the above portable devices for providing power thereto, and an arcuate inner cover 201 clung onto the outer cover 202 for fastening the batteries 203 in the recess 41 of the outer cover 202.

While the invention herein disclosed has been described by means of specific embodiments, numerous modifications and variations could be made thereto by those skilled in the art without departing from the scope and spirit of the invention set forth in the claims.

1. A wrist-carried portable device, comprising:
means including an arcuate recess on an outer surface; and
a battery compartment including one or more flexible, arcuate, thin batteries fitted in the recess, and a cover clung onto the batteries for fastening the batteries in the recess,
wherein the batteries are electrically coupled a circuitry of the means.

2. The device of claim 1, wherein each of the batteries is a lithium polymer battery.

3. The device of claim 1, wherein the means is a bracelet.

4. The device of claim 1, wherein the means is a cellular phone.

5. The device of claim 1, wherein the means is a wrist watch.

6. A wrist-carried portable device, comprising:
means including an arcuate recess on an outer surface; and
a battery compartment including an arcuate outer cover having an arcuate recess on an inner surface, a plurality of spaced batteries disposed in the recess, a link coupled the batteries together, and an arcuate inner cover clung onto the outer cover for fastening the batteries in the recess,
wherein the batteries are electrically coupled a circuitry of the means.

7. The device of claim 6, wherein each of the batteries is a lithium polymer battery.

8. The device of claim 6, wherein the means is a bracelet.

9. The device of claim 6, wherein the means is a cellular phone.

10. The device of claim 6, wherein the means is a wrist watch.
